(19) United States
(12) Patent Application Publication
(10) Pub. No.: US 2012/0235802 A1
(43) Pub. Date: Sep. 20, 2012

(54) VEHICLE EXISTENCE NOTIFICATION APPARATUS

(75) Inventor: Toshiaki NAKAYAMA, Miyoshi-city (JP)

(73) Assignee: DENSO CORPORATION, Kariya-city (JP)

(21) Appl. No.: 13/369,497

(22) Filed: Feb. 9, 2012

(30) Foreign Application Priority Data
Mar. 17, 2011 (JP) 2011-59215

(51) Int. Cl. B60Q 1/00

(52) U.S. Cl. 340/425.5

(57) ABSTRACT

A vehicle existence notification apparatus, disposed in a vehicle, emits a notification sound to notify the surrounding area of the approach or presence of the vehicle. The vehicle existence notification apparatus includes a parametric speaker that serves as a supersonic speaker for emitting a supersonic sound wave, where the parametric speaker performs supersonic modulation to a notification sound signal, which produces the notification sound. The parametric speaker also serves as an audible-sound generating piezoelectric speaker that has a primary resonance component that vibrates at a frequency in an audible frequency band. The parametric speaker sets a supersonic modulation frequency of the notification sound to a sound-pressure increase frequency in a supersonic frequency band reproducible by the audible-sound generating piezoelectric speaker, at which a sound pressure increases due to a high order harmonic resonance.

### CROSS REFERENCE TO RELATED APPLICATION

The present application is based on and claims the benefit of priority of Japanese Patent Application No. 2011-59215, filed on Mar. 17, 2011, the disclosure of which is incorporated herein by reference.

### TECHNICAL FIELD

The present disclosure generally relates to a vehicle existence notification apparatus that generates a notification sound to an area outside of a vehicle, for notifying a pedestrian and the like around the vehicle about the existence of the vehicle.

### BACKGROUND

A vehicle existence notification apparatus is proposed in Japanese Patent Laid-Open No. 2005-289175 (JP '175). The vehicle existence notification apparatus in JP '175 generates a notification sound to notify the existence of the vehicle via a dynamic speaker.

A parametric speaker that generates a sound with a strong directivity may also be used to generate a notification sound at a position distant from the vehicle. The parametric speaker outputs an audible sound from a supersonic speaker after supersonic modulation of the wave form signal of the audible sound. The supersonic wave, which is a non-audible sound, is outputted from the supersonic speaker and has a modulated sound component that is self-demodulated during transmission, thereby reproducing the audible sound (i.e., the notification sound) at a position that is distant from the vehicle.

The supersonic speaker used in the parametric speaker has to generate a compression/dilatation wave having the supersonic-wave wavelength in the air.

### SUMMARY

In view of the above, a supersonic speaker was formed as a collective array of supersonic wave generation elements. For example, FIG. 8A, depicts a supersonic speaker 102 formed as a collective array of supersonic wave generation elements SS (i.e., supersonic vibrator) for generating the supersonic wave, from which the supersonic wave is generated. FIG. 8A is used for illustration purposes, and the technique in FIG. 8A is not a conventional or well-known technique.

In order to generate the compression/dilatation wave having the supersonic-wave wavelength in the air, the vibration mechanism of the supersonic wave generation element SS (i.e., a vibration board and a board driving element) needs to be very light weight, and has to vibrate at the very speed.

More practically, the supersonic wave generation element SS is configured to vibrate a first order resonance unit of the vibration mechanism at a frequency in a supersonic wave frequency band as shown in FIG. 8B (i.e., the first order resonance unit vibrates at a first resonance frequency: such frequency may also be designated as a first component). In this example of FIG. 8B, such frequency band is defined as a frequency of 40 kHz and its proximity.

However, such supersonic wave generation elements SS having an ultra-lightweight vibration mechanism has low versatility, thereby increasing the production cost. As a result, the vehicle existence notification apparatus using such parametric speakers has a high production cost.

In further view of the problems described above, the present disclosure provides for a vehicle existence notification apparatus disposed in a vehicle, where the vehicle existence notification apparatus emits a notification sound to notify the surrounding area of the approach or presence of the vehicle. The vehicle existence notification apparatus includes a parametric speaker that emits a supersonic sound wave, where the parametric speaker performs supersonic modulation to a notification sound signal, which produces the notification sound. The parametric speaker also serves as an audible-sound generating piezoelectric speaker that has a primary resonance component that vibrates at a frequency in an audible frequency band. The parametric speaker sets a supersonic modulation frequency of the notification sound to a sound-pressure increase frequency in a supersonic frequency band reproducible by the audible-sound generating piezoelectric speaker, at which a sound pressure increases due to a high order harmonic resonance.

By using such configuration, the audible-sound generating piezoelectric speaker can generate the supersonic sound wave that is emitted from the parametric speaker as a supersonic sound wave. As a result, due to the cost reduction of the supersonic speaker which is mass-produced and versatile, the total cost of the vehicle existence notification apparatus is reduced.

The control circuit generates, from the audible-sound generating piezoelectric speaker, the sound wave in the audible frequency band. By generating the sound wave in the audible frequency band from the audible-sound generating piezoelectric speaker, the notification sound is generated/reproduced in an area that is outside of a directivity range of the parametric speaker.

The control circuit simultaneously generates, from the audible-sound generating piezoelectric speaker for generating the audible sound, the sound waves in multiple frequencies at least in the audible frequency band, which form a chord relationship with each other. In such configuration, even if a resonance sound is generated in the audible frequency band from the audible-sound generating piezoelectric speaker in a course of generating the supersonic sound wave, such resonance sound sounds as a part of a chord, thereby easing the discomfort caused by the resonance sound.

### BRIEF DESCRIPTION OF THE DRAWINGS

Objects, features, and advantages of the present disclosure will become more apparent from the following detailed description made with reference to the accompanying drawings, in which:

FIG. 1A is an illustration of an arrangement of audible-sound generating piezoelectric speakers of the present disclosure;

FIG. 1B is an illustration of a frequency characteristics of the piezoelectric speakers of FIG. 1A;

FIG. 2 is a block diagram of a vehicle existence notification apparatus of the present disclosure;

FIG. 3 is an illustration of a vehicle existence notification apparatus of the present disclosure;

FIG. 4A is a cross-sectional view of the vehicle existence notification apparatus of the present disclosure;

FIG. 4B is a perspective view of the vehicle existence notification apparatus of the present disclosure;

FIG. 5 is a diagram of a frequency characteristic of a vehicular horn of the vehicle existence notification apparatus of the present disclosure;

FIGS. 6A and 6B are illustrations of outreach areas of a notification sound of the present disclosure;

FIGS. 7A, 7B, 7C, 7D and 7E are illustrations of an operation principle of a parametric speaker of the vehicle existence notification apparatus of the present disclosure;

FIG. 8A is an illustration of an arrangement of a supersonic wave generation element as a comparative example; and

FIG. 8B is an illustration of a frequency characteristic of the supersonic wave generation elements of FIG. 8A.

### DETAILED DESCRIPTION

With reference to the drawings, embodiments of the present disclosure are explained. In the following examples, like parts have like numbers. The following description is merely exemplary in nature and is in no way intended to limit the discloser, its application, or uses.

### First Embodiment

A vehicle is equipped with a vehicle existence notification apparatus. The vehicle may be an electric vehicle that is powered by a battery or fuel cell technology, or may be a hybrid car that is powered by a motor and an engine, where the engine is turned off during travel or stop of the vehicle. The vehicle is mainly a quiet vehicle that generates very little to no noise or sound, and is typical not equipped with an engine. The vehicle existence notification apparatus notifies pedestrians of the existence or presence of the vehicle by way of a notification sound, which may be a single sound, a chord sound, a piece of music, a pseudo engine sound, and the like.

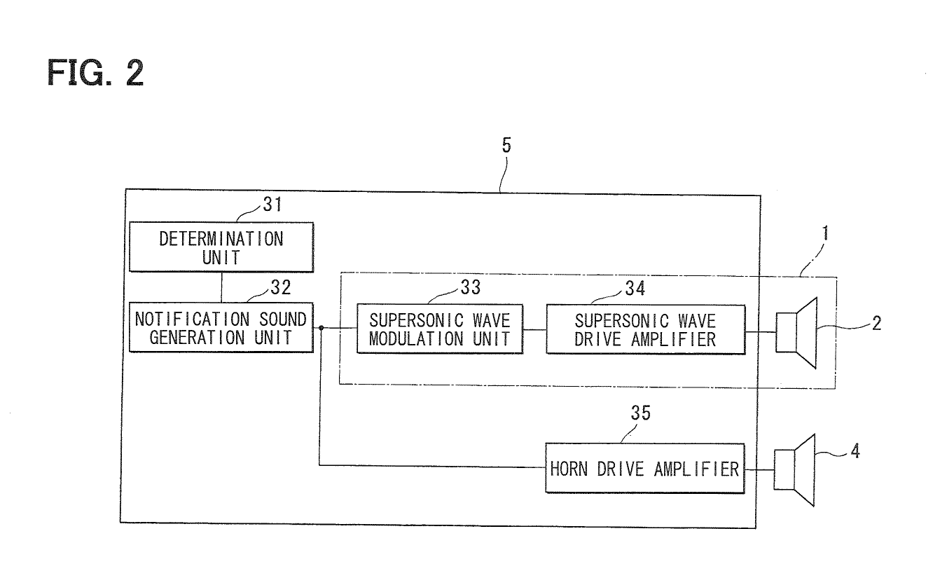

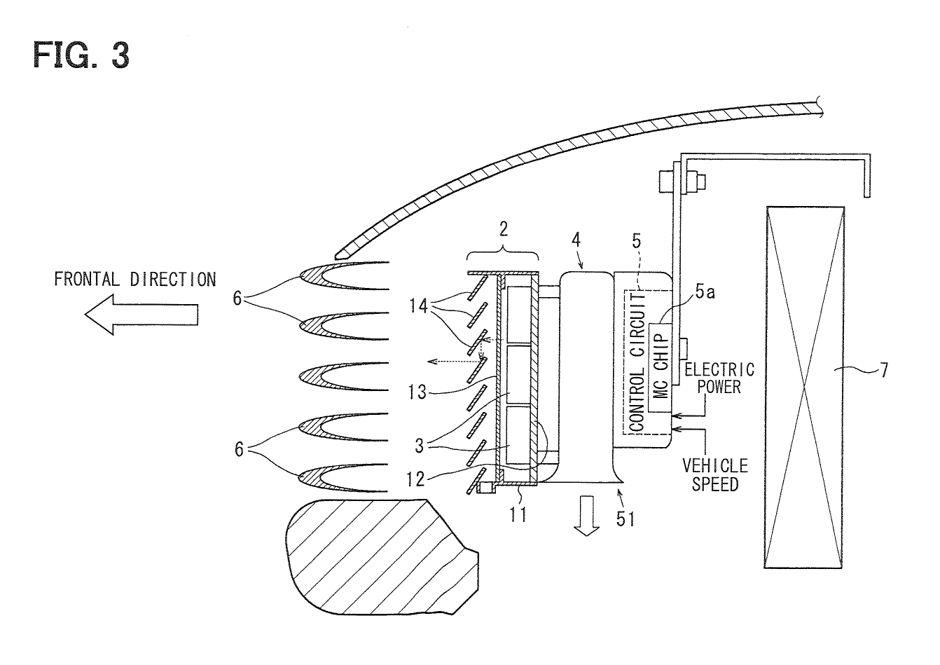

With reference to FIGS. 2 and 3, the vehicle existence notification apparatus includes a parametric speaker 1, a vehicular horn 4, and a control unit 5. The parametric speaker emits a supersonic sound wave via a supersonic speaker 2. The vehicular horn 4 emits the notification sound in the audible frequency band towards an area outside of the vehicle. The control circuit 5 controls the operation of the parametric speaker 1 and the vehicular horn 4.

(Parametric Speaker 1)

The parametric speaker 1 includes the supersonic speaker 2. The supersonic speaker 2 generates air vibration, as a supersonic wave, at a frequency that is higher than the audible range of the human ear, such as a frequency equal to or greater than 20 kHz. The supersonic speaker 2 emits the supersonic sound wave outward from the vehicle.

The supersonic speaker 2 of the present embodiment is disposed in a frontal portion of the vehicle. Specifically, the supersonic speaker 2 is arranged on a front surface of the vehicular horn 4, where the front surface of the vehicular horn 4 faces a front grille 6 and a frontal direction of the vehicle. The vehicular horn 4 and the supersonic speaker 2 are arranged between the front grille 6 and a heat exchanger 7. The supersonic speaker 2 is arranged to output the supersonic sound wave in the frontal direction of the vehicle, where frontal direction can be described as towards the front grille 6 outward to an area outside of the vehicle.

The supersonic speaker 2 includes a plurality of piezoelectric speakers 3 for generating the supersonic sound wave, and a supersonic speaker house 11 to house the piezoelectric speakers 3.

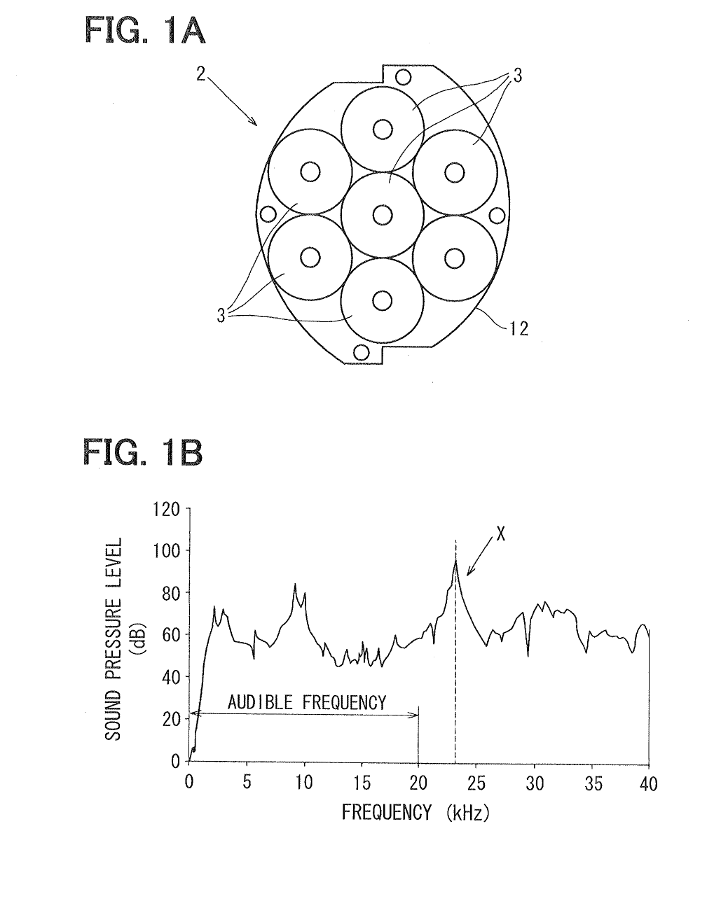

With reference to FIG. 1A, the piezoelectric speakers 3 are installed on a support board 12 that is affixed to the supersonic speaker housing 11, and the piezoelectric speakers 3 are arranged on the support board 12 as a speaker array. Further, each of the piezoelectric speakers 3 is made of a piezoelectric element that causes expansion and contraction according to an applied voltage (i.e., charge and discharge of the electric current) and a vibration board that causes a compression wave according to such expansion/contraction of the piezoelectric element.

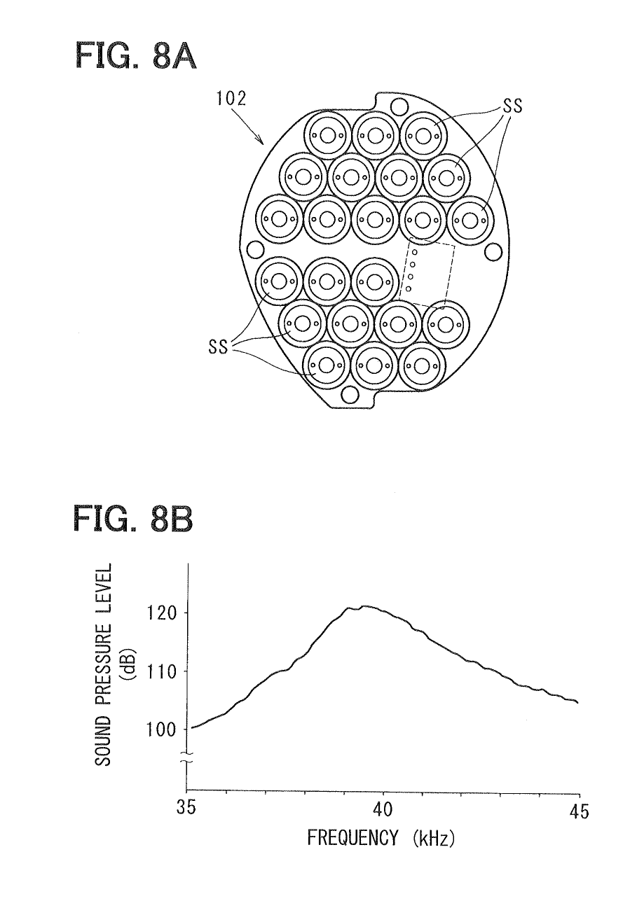

Each of the piezoelectric speakers 3 of the supersonic speaker 2 is a device that is made to generate a sound wave in the audible frequency band, instead of a device, such as a supersonic sound wave generation element SS of FIG. 8A that generates a supersonic sound. The primary resonance component of the sound wave from the piezoelectric speaker 3, which may be the first resonance frequency or the first order component, exists in the audible frequency band.

More practically, each of the piezoelectric speakers 3 of the present embodiment is provided as a diversion of a speaker that is installed to provide vehicle information as the audible sensation (i.e., sound, voice, warning tone or the like) for the occupant of the vehicle. The outer dimension of the piezoelectric speaker 3 in the present embodiment is, in comparison to the supersonic sound wave generation element SS in FIG. 8A, doubled for suitably generating the sound wave in the audible frequency.

The piezoelectric speaker 3 of the present embodiment is used to generate the sound wave in the audible frequency as described above, and has frequency characteristics (i.e., a reproducible sound frequency range) of FIG. 1B if a sweep signal in a sine wave form (i.e., a variable signal transiting from a low frequency to a high frequency) having a predetermined voltage V (unit: volt) is provided.

As shown in FIG. 1B, the primary resonance component (i.e., first order component) of the sound wave from the piezoelectric speaker 3 in the present embodiment exists in the audible frequency band (e.g., in this example, at around 2 kHz). This characteristic is also an indication that the piezoelectric speaker 3 of the present embodiment is disposed for generating the audible sound.

On the other hand, while the piezoelectric speaker 3 of the present embodiment is disposed for generating the audible sound as described above, the sound wave from the piezoelectric speaker 3 has a sound pressure increase frequency X due to the high order resonance (i.e., a high order resonance frequency: more practically, a seventh resonance component, a seventh order component), at around 23 kHz, in the supersonic frequency band, as shown in FIG. 1B.

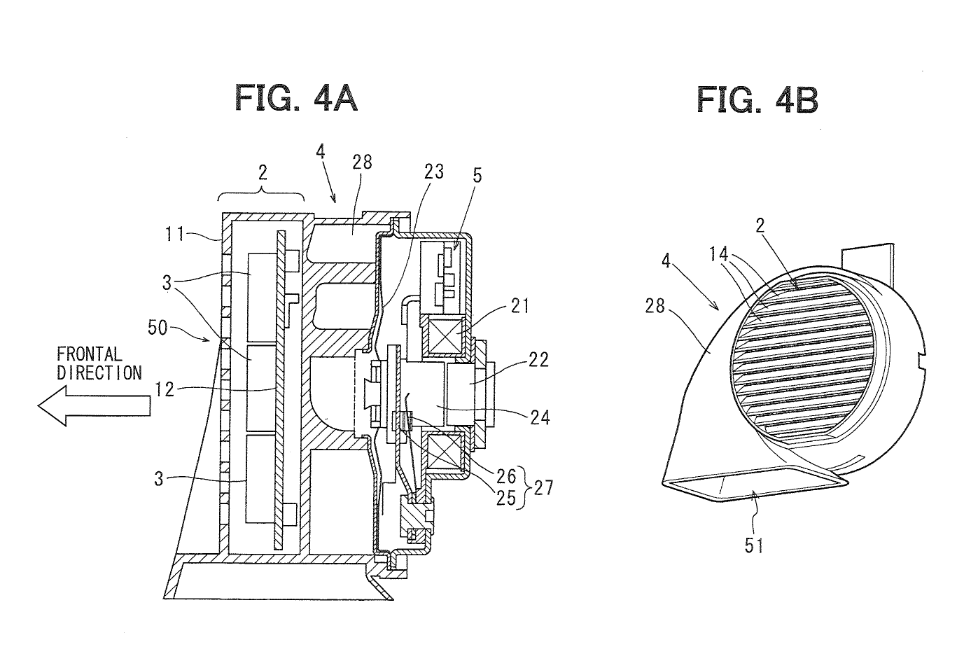

With reference now including FIGS. 4A and 4B, the supersonic speaker housing 11 has a speaker opening 50 from which the supersonic sound wave is outputted toward the frontal direction of the vehicle from each of the piezoelectric speakers 3. The speaker opening 50 includes a waterproof device that prevents intrusion of water into an installation position of each of the piezoelectric speakers 3. By way of example the waterproof device may be a waterproof sheet 13 that permeably transmits the supersonic sound and a louver 14 that is disposed in front of the waterproof sheet 13 are used (FIG. 3).

(Vehicular Horn 4)

As provided earlier, the vehicular horn 4 is disposed between the front grille 6 and the heat exchanger 7. The vehicular horn 4 may be an electro-magnetic type horn that generates a warning sound when a horn switch (e.g., a horn button on a steering wheel) is operated by a user of the vehicle.

The vehicular horn 4 includes a coil 21 to generate a magnetic force, a fixed iron core 22, a moveable iron core 24, and a movable contact point 26. The fixed iron core 22 outputs an attraction force that is generated by way of the magnetic force from the coil 12, and may be referred to as a magnetic attraction core.

The movable iron core 24 is supported at the center of a vibration board 23 (i.e. a diaphragm). The attraction force provided by the fixed iron core 22, moves the movable iron core 24 towards the fixed iron core 22, and as a result, the movable contact point 26 decouples from a fixed contact point 25, which interrupts the electric current supplied to the coil 21.

In particular, when the horn switch is engaged, the vehicular horn 4 generates a self-excitation voltage above a threshold voltage, such as (8V or more. The self-excitation voltage is provided to the coil 21 via power terminal that are coupled to the ends of the coil 21, and current flows across the coil 21. When the self-excitation voltage is above the threshold, an attracting action and a returning action is repeatedly performed within the vehicular horn 4.

Specifically, in regards to the attraction action, when the current flows through the coil 21, an electromagnetic fields is generated and an attraction occurs between the movable iron core 24 and the fixed iron core 22, such that the movable iron core 24 moves towards the fixed iron core 22. Due to the movement of the moveable iron core 24 towards the fixed iron core 22, the moveable contact point 26 decouples from the fixed contact point 25, causing the current to stop flowing through the coil 21.

Once, the current has stopped flowing through the coil 21, the electromagnetic field is no longer generated and the moveable iron core 24 returns to its initial position, which is the start of the returning action. Due to the biasing of the movable iron core 24, the moveable contact point 26 couples with the fixed contact point 25, and the current resumes flowing through the coil 21, thus restarting the attracting action.

In other words, when the self-excitation voltage is equal to or greater than the threshold voltage, the current flows through the coil 21, and an electric current interrupter 27, which allows and prevents the current from flowing through the coil 21, is formed by the fixed contact point 25 and the moveable contact point 26

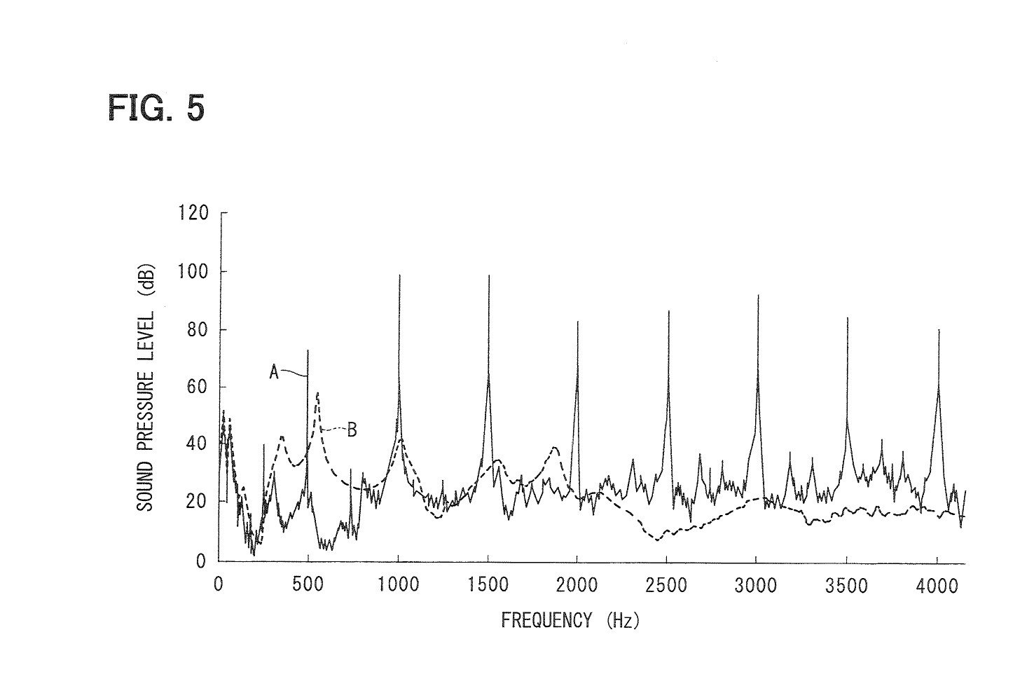

Due to the attracting and returning action, the movable iron core 24 causes a vibration of the vibration board 23, and the vehicular horn 4 generates the warning sound. The frequency characteristics of the warning sound produced by the vehicular horn 4 based on a continuous supply of the self-excitation voltage is shown by a solid line A in FIG. 5.

Further, in the present embodiment, the vehicular horn 4 is operated as a dynamic speaker by providing the coil 21a driving signal of a separate excitation voltage that is lower than the self-excitation voltage for the vehicular horn 4 (e.g., a voltage lower than 8 V).

The vehicular horn 4 may also be used as a dynamic speaker even by the self-excitation voltage. Specifically, the self-excitation voltage can be quickly coupled and decoupled to the coil 21 within a short period of time, such as through pulse width modulation (PWM), such that the connection and disconnection of the electric current interrupter 27 is prevented (i.e. the attraction action and returning action is not repeatedly performed).

The frequency characteristics of the vehicular horn 4 at a time of using the vehicular horn 4 as a dynamic speaker is shown by a broken line B of FIG. 5. The broken line B shows the frequency characteristics when a sweep signal of 1 V in a sine wave form (i.e., a variable signal transiting from a low frequency to a high frequency) is provided to the vehicular horn 4.

With reference to FIG. 4B, the vehicular horn 4 of the present embodiment, is equipped with a swirl shape horn 28 (i.e., a trumpet member or a sound tube in a swirl shape) that has a slightly curved body that defines a horn opening 51. The swirl shape horn 28 amplifies the sound generated by the vibration of the vibration board 23, and emits or outputs the amplified sound outward from the vehicle to the surrounding area via the horn opening 51. It would be apparent to one skilled in the art that the vehicular horn 4 is not limited to include a swirl shape horn configuration, and may another shape, such as a disc shape horn or the like.

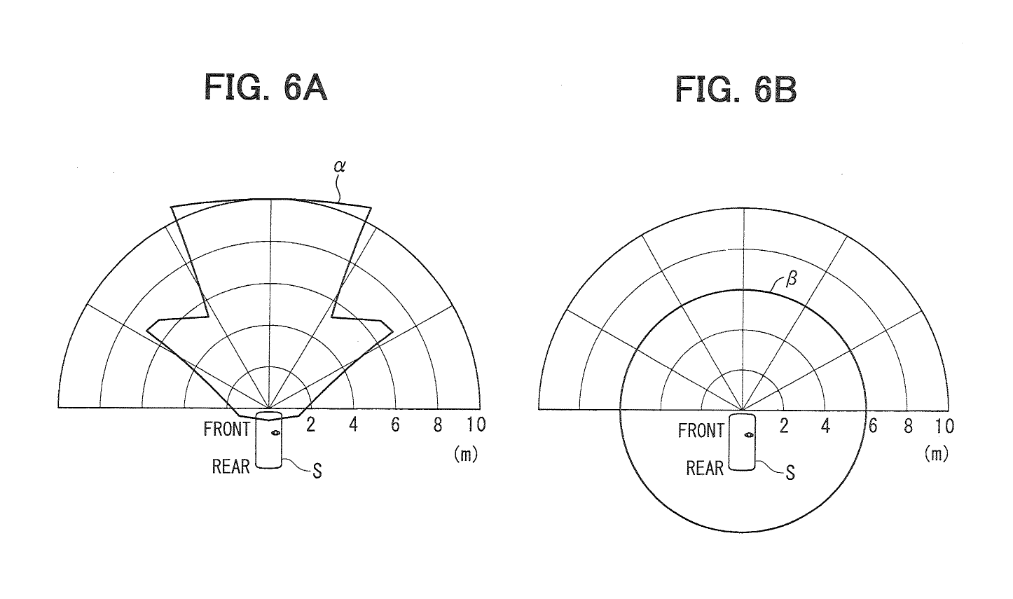

With reference to FIGS. 6A and 6B, FIG. 6A shows a coverage area a of the notification sound from the parametric speaker 1, and FIG. 6B shows an coverage area β of the notification sound from the vehicular horn 4, where the vehicle is identified as S in FIGS. 6A and 6B. The coverage areas α and β in FIGS. 6A and 6B shows the area of the notification sound with its sound pressure measured as 50 dB or greater.

As described above, the supersonic speaker 2 of the present embodiment is disposed in a front area of the vehicle and outputs the supersonic sound wave toward a frontal direction of the vehicle.

The vehicular horn 4 is arranged to output the supersonic sound wave substantially evenly around the vehicular horn 4, if seen from the top of the vehicle. More practically, the horn opening 51 of the swirl shape horn 28 in the vehicular horn 4 is directed in a downward direction of the vehicle to face the road surface. The direction of the opening of the horn 28 may also be set to a different direction (e.g., in an upward direction or side direction), and the supersonic sound wave from the opening in such direction may be reflected by a reflector or the like to be directed in a specific direction, including a downward direction of the vehicle.

(Control Circuit 5)

The control circuit 5 has a microcomputer chip 5a disposed on a substrate as shown in FIG. 3, and is disposed inside of the vehicular horn 4 (e.g., in an inside surface of a horn housing) as shown in FIG. 4A. However, the control circuit 5 may not necessarily be limited to such configuration.

The control circuit 5 includes, as shown in FIG. 2:

(a) a determination unit 31 for determining whether a driving condition of the vehicle is suitable for generating the notification sound,

(b) a notification sound generation unit 32 for generating a notification sound signal when the determination unit 31 determines the driving condition of the vehicle is suitable for generating the notification sound,

(c) a supersonic modulation unit 33 for modulating the notification sound signal into a sound signal having a supersonic frequency,

(d) a supersonic drive amplifier 34 for driving the supersonic speaker 2 (i.e., the multiple piezoelectric speaker 3), and

(e) a horn drive amplifier 35 for driving the vehicular horn 4.

In the following, the above components (a) to (e) of the control circuit 5 are explained.

(Determination Unit 31)

The determination unit 31 is configured to evaluate the driving condition of the vehicle to determine if a notification sound should be generated. For example, when the speed of the traveling vehicle is equal to or lower than a predetermined value, such as 20 km/h, the determination unit 31 may determine that a notification sound is needed, and sends an operation instruction to the notification sound generation unit 32 to generate a notification sound. Therefore the determination unit 31 may include various predetermined driving conditions that would require a notification sound.

(Notification Sound Generation Unit 32)

Upon receiving the operation instruction from the determination unit 31, the notification sound generation unit 32, implemented as a notification sound generation program (i.e., a sound software), generates a notification sound signal (i.e., an electric signal having the audible frequency) according to a digital technology.

(Supersonic Sound Wave Modulation Unit 33)

The supersonic modulation unit 33 performs supersonic modulation on the notification sound signal that is provided by the notification sound generation unit 32.

An example of the supersonic modulation unit 33 is provided in the present embodiment as a device that performs amplitude modulation (AM), in which an output signal of the notification sound generation unit 32 is modulated to have a supersonic frequency, such as a sound-pressure increase frequency X due to the high order harmonic resonance existing in a supersonic frequency band, which can be reproduced by the audible-sound generating piezoelectric speaker (a frequency at around 23 kHz). In other words, the notification sound signal is modulated to have the supersonic frequency at or around a frequency X where the sound pressure increases.

Further, the supersonic modulation unit 33 may not necessarily be limited to AM modulation. That is, the supersonic modulation unit 33 may be another type of modulation device such as a pulse-width modulation (PWM) for modulating the output of the notification sound generation unit 32 to a predetermined “pulse width change in the supersonic frequency band (i.e., change of the pulse generation time)” or the like.

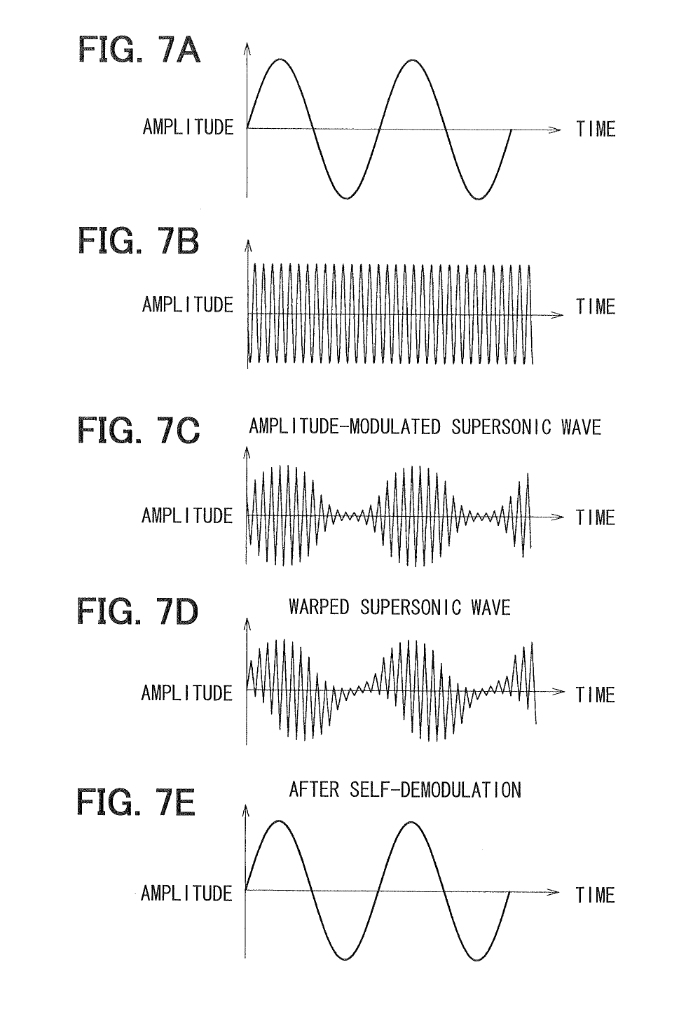

An example of the supersonic sound wave modulation by the supersonic modulation unit 33 is explained with reference to FIGS. 7A to 7E.

The following explanation assumes that the notification sound signal input into the supersonic modulation unit 33 is a voltage change shown in FIG. 7A. For the ease of understanding, the voltage change is depicted as a wave form of a single frequency in FIG. 7A.

On the other hand, the supersonic modulation unit 33 includes an oscillation unit that oscillate at a supersonic sound wave frequency (i.e., a supersonic sound wave frequency X at which a sound pressure increases) as shown in FIG. 7B. Further, the oscillation unit may form a predetermined supersonic sound wave frequency based on a clock signal of a clock in the microcomputer chip 5a, or may use a frequency modulation oscillator that is separately disposed from the microcomputer chip 5a.

Further, the supersonic modulation unit 33 shown in FIG. 7C performs the following:

(i) the supersonic modulation unit 33 increases the amplitude of the voltage according to the supersonic oscillation, in proportion to the increase of the signal voltage of the frequency of the notification sound signal, and

(ii) the supersonic modulation unit 33 decreases the amplitude of the voltage according to the supersonic oscillation, in proportion to the decrease of the signal voltage of the frequency of the notification sound signal.

In the above-described manner, the supersonic modulation unit 33 modulates the notification sound signal from the notification sound generation unit 32 to generate an amplitude change of the oscillation voltage having the supersonic frequency.

(Supersonic Drive Amplifier 34)

The supersonic drive amplifier 34 drives the supersonic speaker 2 based on the supersonic signal modulated by the supersonic modulation unit 33 (e.g., a push-pull type power amplifier), which generates the supersonic sound wave from each of the piezoelectric speakers 3 by the modulation of the notification sound signal according to the control of the applied voltage (i.e., charge and discharge of the electric current) to each of the piezoelectric speakers 3.

(Horn Drive Amplifier 35)

The behavior of the horn drive amplifier 35 is explained in the following:

(i) the horn drive amplifier 35 has a power amplifier function that amplifies the notification sound signal to generate the notification sound in the audible frequency from the vehicular horn 4 by operating the vehicular horn 4 as the dynamic speaker while the notification sound generation unit 32 generates the notification sound signal, and

(ii) the horn drive amplifier 35 has a continuous ON function to generate the warning sound from the vehicular horn 4 by applying the battery voltage to the vehicular horn 4 while the horn switch is being operated.

(Operation of the Vehicle Existence Notification Apparatus)

When the driving condition of the vehicle is suitable for generating the notification sound, the notification sound generation unit 32 outputs a notification sound signal, and, as shown in FIG. 7C, outputs the supersonic sound wave (i.e., inaudible sound) based on the modulation of a notification sound signal toward the front of the vehicle.

Subsequently, the supersonic sound wave having a short wavelength is warped by the viscosity of the air as the supersonic sound wave travels in the air, as shown in FIG. 7D.

As a result, as shown in FIG. 7E, the amplitude components in the supersonic sound wave are self-demodulated during the travel in the air, to reproduce the notification sound in front of the vehicle.

On the other hand, the notification sound is output as the audible sound directly from the vehicular horn 4 toward the surroundings of the vehicle according to the output of the notification sound signal from the notification sound generation unit 32.

(Advantageous Effects of the First Embodiment)

The supersonic speaker 2 of the present embodiment is implemented as the piezoelectric speaker 3 that is disposed to generate the sound wave in the audible frequency band, as described above. In other words, the audible-sound generating piezoelectric speaker 3 generates the supersonic sound wave used in the parametric speaker 1.

The piezoelectric speaker 3 for generating the audible sound is low in production cost due to its versatility and mass production. Therefore, the supersonic speaker 2 of the present embodiment having such piezoelectric speaker 3 can be produced at low costs, thereby enabling the low-cost production of the vehicle existence notification apparatus using such parametric speaker 1.

### Second Embodiment

The second embodiment of the present disclosure is now described. Since each of the piezoelectric speakers 3 in the supersonic speaker 2 is arranged for generating the audible sound, as described above, the piezoelectric speakers 3 can directly emit a sound wave (i.e., an audible sound) of the audible frequency.

Therefore, the control circuit 5 of the second embodiment simultaneously generates a sound wave in the audible frequency band and a supersonic sound wave.

More practically, the control circuit 5 provides, for the supersonic drive amplifier 34, a supersonic sound wave signal modulated by the supersonic modulation unit 33, and a notification sound signal, which bypasses the supersonic modulation unit 33, to drive each of the piezoelectric speakers 3.

In such manner, the following sounds are generated:

(i) in an inside of a directivity range of the parametric speaker 1, a composite sound that is made up of a notification sound directly reproduced by the parametric speaker 1 and a notification sound directly emitted as an audile sound from the piezoelectric speaker 3 is generated, and

(ii) in an outside of the directivity range of the parametric speaker 1, only the notification sound directly emitted as an audile sound from the piezoelectric speaker 3 is generated.

Therefore, by emitting the sound wave in the audible frequency band from each of the piezoelectric speakers 3, the notification sound is generated in an outside of the directivity range of the parametric speaker 1.

(Modification of the Second Embodiment)

In the above example, a supersonic sound wave and a sound wave in the audible frequency band are emitted at the same time. However, depending on the driving condition of the vehicle only the sound wave in the audible frequency band may be generated by each of the piezoelectric speakers 3.

In other words the following two driving conditions may appropriately be switched:

(i) One driving condition in which the notification sound is generated by the parametric speaker 1 based on the generation of the supersonic sound wave by each of the piezoelectric speakers 3.

(ii) The other driving condition in which the notification sound in the audible frequency band is generated directly by each of the piezoelectric speakers 3.

### Third Embodiment

The piezoelectric speakers 3 are capable of generating the supersonic sound wave and a sound wave in the audible frequency band, as described above. Therefore, when the piezoelectric speaker 3 generates the supersonic sound, it may generate a resonance sound in the audible frequency band at the same time.

Thus, in the present embodiment, the vehicle existence notification apparatus generates multiple sound waves in different frequencies in the audible frequency band from each of the piezoelectric speakers 3 at the same time, and those sound waves are arranged to have a chord relationship with each other, which makes up a composite sound that sounds as a comfortable sound to the human ear.

More practically, if the piezoelectric speaker 3 generates a resonance sound of A Hz in the audible frequency band while generating a supersonic sound wave, the vehicle existence notification apparatus of the present embodiment simultaneously generates, by the piezoelectric speaker 3, a first supplemental frequency of B Hz and a second supplemental frequency of C Hz. Further, the frequencies of A Hz, B Hz, C Hz make up a chord relationship, by defining a frequency ratio of 4:5:6, for example. That is, a combination of “do, mi, so,” or “fa, la, do,” or “so, si (ti), re,” makes a harmonic sound, for example.

By generating the first and second supplemental frequencies by the piezoelectric speaker 3, the resonance sound from the piezoelectric speaker 3 in the audible frequency band is absorbed in a chord relationship, thereby easing the discomfort caused by the resonance sound.

### INDUSTRIAL APPLICABILITY

In the above-described embodiments, the piezoelectric speaker 3 for generating the audible sound is used as it is without any modification. However, the vibration board may be modified to have a weight added thereon, or a part of the vibration board may be cut out, for the purpose of changing its resonance frequency and setting the higher resonance portion in the supersonic frequency band (i.e., the sound pressure increase frequency X) to have a desired frequency.

In the embodiment described above, the notification sound is also generated from the dynamic speaker of the vehicle existence notification apparatus (i.e., the vehicular horn 4 the above embodiment). However, the notification sound may be generated by using the supersonic speaker 2 only.

Based on the foregoing, the vehicle existence notification apparatus notifies the existence of the vehicle by using a notification sound, and includes the parametric speaker 1 for outputting, toward an outside of a vehicle, a supersonic wave (i.e., ultrasound, ultrasonic wave or the like) that is made by supersonic modulation of a frequency signal of the notification sound.

In such parametric speaker 1, a supersonic speaker 2 for generating the supersonic sound is implemented as an audible-sound generating piezoelectric speaker 3 for generating a sound wave having its primary resonance component (i.e., the first order component) vibrating at a frequency in the audible frequency band (i.e., the piezoelectric speaker which generates the sound wave in the audible frequency band).

Further, a supersonic modulation frequency set by the parametric speaker 1 is configured to a sound-pressure increase frequency X at which a sound pressure increases due to a high order harmonic resonance, and such sound-pressure increase frequency X is a frequency in a supersonic frequency band reproduced by the audible-sound generating piezoelectric speaker 3 (i.e., a frequency range in which a sound pressure increases).

What is claimed is:

1. A vehicle existence notification apparatus for notifying existence of a vehicle by generating a notification sound, the apparatus comprising:
a parametric speaker configured to emit a supersonic sound wave outward from the vehicle, the parametric speaker performs supersonic modulation to a notification sound signal, the notification sound signal generates the notification sound, wherein
the parametric speaker serving as a supersonic speaker for generating the supersonic sound wave is implemented as an audible-sound generating piezoelectric speaker that has a primary resonance component that vibrates at a frequency in an audible frequency band,
the parametric speaker sets a supersonic modulation frequency of the notification sound to a sound-pressure increase frequency in a supersonic frequency band reproducible by the audible-sound generating piezoelectric speaker, at which a sound pressure increases due to a high order harmonic resonance.

2. The vehicle existence notification apparatus of claim 1 further comprising:
a control circuit configured to control the supersonic speaker and the audible-sound generating piezoelectric speaker, wherein
the control circuit controls the audible-sound generating piezoelectric speaker to generate a sound wave in the audible frequency band.

3. The vehicle existence notification apparatus of claim 2, wherein
the control circuit simultaneously generates sound waves in a plurality of frequencies at least in the audible frequency band by controlling the audible-sound generating piezoelectric speaker, and
the sound waves in the plurality of frequencies form a chord relationship.
